(19) United States
(12) Patent Application Publication
(10) Pub. No.: US 2023/0410187 A1
(43) Pub. Date: Dec. 21, 2023

(54) SYSTEMS AND METHODS FOR DYNAMICALLY CONTROLLING DISPLAY OF SEARCH RESULTS

(71) Applicant: Shopify Inc., Ottawa (CA)

(72) Inventors: Maher Mohamed Gamal Aly ABDALLA, Milton (CA); Charles Duze, Sammamish, WA (US); Indra Pal Singh, Ottawa (CA)

(73) Assignee: Shopify Inc., Ottawa (CA)

(21) Appl. No.: 17/841,932

(22) Filed: Jun. 16, 2022

(51) Int. Cl. G06Q 30/06; H04L 67/50; G06F 16/9535

(52) U.S. Cl. CPC G06Q 30/0641; G06Q 30/0631; H04L 67/535; G06F 16/9535

(57) ABSTRACT

A computer-implemented method is disclosed. The method includes: obtaining search results in response to a search query initiated via a graphical user interface on a computing device; displaying, on the graphical user interface, a first subset of the search results; obtaining user engagement data representing user interaction with the first subset of the search results via the graphical user interface; determining a second subset of the search results including only search result items that are not included in the first subset; and causing search result items of the second subset to be displayed on the graphical user interface in a display order that is based on the user engagement data.

### TECHNICAL FIELD

The present disclosure relates to graphical user interfaces, and more particularly to, methods for controlling display of search results on computing devices.

### BACKGROUND

Conventional search engines produce static results in response to search queries. Search results are typically presented in a list, for example, on a search engine results page. The display of search results can have a significant effect on influencing user engagement, such as selection, clickthrough, etc., with the search results.

### BRIEF DESCRIPTION OF THE DRAWINGS

Embodiments will be described, by way of example only, with reference to the accompanying figures wherein:

FIG. 1 illustrates a networked computing environment in accordance with example embodiments of the present application;

FIG. 2 is a block diagram of an e-commerce platform that is configured for implementing example embodiments of a platform search engine;

FIG. 3 shows, in flowchart form, an example method for controlling display of search results on a computing device;

FIG. 4 shows, in flowchart form, an example method for determining an order of display of search results;

FIG. 5 shows, in flowchart form, another example method for determining an order of display of search results;

FIG. 6A illustrates displayed search results of a search query on a graphical user interface;

FIG. 6B shows a table which may be used for determining a display order for displaying non-displayed search results based on user engagement data;

FIG. 7A is a high-level schematic diagram of a computing device;

FIG. 7B shows a simplified organization of software components stored in a memory of the computing device of FIG. 7A;

FIG. 8 is a block diagram of an e-commerce platform, in accordance with an example embodiment; and

FIG. 9 is an example of a home page of an administrator, in accordance with an example embodiment.

Like reference numerals are used in the drawings to denote like elements and features.

### DETAILED DESCRIPTION OF EMBODIMENTS

In an aspect, the present application discloses a computer-implemented method. The method includes: obtaining search results in response to a search query initiated via a graphical user interface on a computing device; displaying, on the graphical user interface, a first subset of the search results; obtaining user engagement data representing user interaction with the first subset of the search results via the graphical user interface; determining a second subset of the search results including only search result items that are not included in the first subset; and causing search result items of the second subset to be displayed on the graphical user interface in a display order that is based on the user engagement data.

In some implementations, the method may further include determining the display order based on assigning, to each of one or more of the search result items of the second subset, a rank representing a user interest level associated with the search result item based on the user engagement data.

In some implementations, the rank that is assigned to a search result item may be based on the user engagement data and attributes of interest associated with one or more search result items of interest from the first subset.

In some implementations, the user engagement data may include first data characterizing one or more user interface actions performed subsequent to display of the first subset of the search results on the graphical user interface.

In some implementations, the one or more user interface actions may include a click action.

In some implementations, the one or more user interface actions may include a scroll action and the first data may indicate, for the scroll action, at least one of a scroll speed or changes in scroll position.

In some implementations, the user engagement data may include second data characterizing passive interaction with the first subset of the search results.

In some implementations, the second data may include at least one of view-through data or a dwell time associated with a search result item.

In some implementations, the search query may comprise a product search performed on an e-commerce platform and the search results may include a plurality of product item listings associated with the product search.

In some implementations, the search query may comprise an app search performed on a software distribution platform and the search results may include a plurality of app listings associated with the app search.

In some implementations, the method may further include detecting a defined trigger condition for displaying further search results, and the second subset of the search results may be caused to be displayed responsive to detecting the defined trigger condition.

In some implementations, the defined trigger condition may include at least one of a scroll action, a selection of a user interface element, or a selection of a redirect link to return to a listing of the search results.

In another aspect, the present application discloses a computing device including a processor and a memory coupled to the processor. The memory stores computer-executable instructions that, when executed by the processor, configure the processor to: obtain search results in response to a search query initiated via a graphical user interface on a computing device; display, on the graphical user interface, a first subset of the search results; obtain user engagement data representing user interaction with the first subset of the search results via the graphical user interface; determine a second subset of the search results including only search result items that are not included in the first subset; and cause search result items of the second subset to be displayed on the graphical user interface in a display order that is based on the user engagement data.

In yet another aspect, the present application discloses a non-transitory, computer-readable storage medium. The computer-readable storage medium may store processor-executable instructions that, when executed, cause one or more processors to carry out the operations of one or more of the methods or processes described herein.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the present application, the term “e-commerce platform” refers broadly to a computerized system (or service, platform, etc.) that facilitates commercial transactions, namely buying and selling activities over a computer network (e.g., Internet). An e-commerce platform may, for example, be a free-standing online store, a social network, a social media platform, and the like. Customers can initiate transactions, and associated payment requests, via an e-commerce platform, and the e-commerce platform may be equipped with transaction/payment processing components or delegate such processing activities to one or more third-party services. An e-commerce platform may be extendible/extensible by connecting one or more additional sales channels representing platforms where products can be sold. In particular, the sales channels may themselves be e-commerce platforms, such as Facebook Shops™, Amazon™, etc. The e-commerce platform may serve one merchant in some implementations. The e-commerce platform may be a multi-merchant platform in other cases, where each merchant is able to use some or all of the available services to configure an online storefront and provide commerce services to customers of the online storefront. A multi-merchant e-commerce platform may operate across a range of geographic regions, and may operate in multiple countries, currencies, and time zones.

### Search Engines and Information Systems

Search engines are widely implemented in information systems. Various types of searches, such as semantic search, lexical search, etc., may be performed on data that is available in databases or repositories associated with information systems. By way of example, an e-commerce platform may include a product-based search engine for handling customer search queries relating to merchants and/or products that are associated with the e-commerce platform. An information system may use a third-party search service for processing search queries. Alternatively, an information system may implement its own search engine, employing an algorithm that is suitable for the datasets of the information system.

Conventional search engines produce static results in response to search queries. Search results are typically presented in a list, for example, on a search engine results page. The order in which search results are presented to users may be determined by the search engine's algorithm. That is, the search algorithm may be determinative of the display order of the search results. Once the search results are presented to a user (e.g., on the user's device), the display order may be altered manually by the user. For example, a user may sort and/or filter search results using a defined set of sorting/filtering criteria.

The traditional approaches to displaying search results are limited. Search engines provide a fixed, small number of search criteria that users can define at the outset of a search, which leaves users with limited control over the parameters of the search. Users are presented with search results in an order that is determined by the search engine, with minimal input from the users. In particular, search results may be displayed in a manner that is not customized for individual users. As a result, users may spend a substantial amount of time reviewing the search results before arriving at a desired result or, in the alternative, take on the burden of performing additional searches with more narrowly defined search criteria. While users may sometimes have options for sorting or filtering search results, the predefined sort/filter criteria for a search are generally limited and may not correspond closely to metrics for user interest in the search results. Moreover, the sorting/filtering of search results simply represents a display of the search results according to a different order that is also determined by the search engine, not the user. As such, sorting or filtering of search results does not provide effective customization of the display of search results for users.

The present application describes solutions for addressing some of the aforementioned technical limitations associated with conventional search engines. A system and methods for controlling the display of search results on computing devices are disclosed. As will be described in detail below, the disclosed system uses real-time interaction data representing user interaction with displayed search results of a search for dynamically ordering the search results that have not been displayed to the user. The system is configured to infer user interest levels associated with search results that have been displayed to a user, based on explicit or implicit user interactions with the search results that are detected by the system. Specifically, the system may obtain real-time user interaction data for a currently displayed subset of search results and determine, based on the interaction data, the user's levels of interest in connection with the displayed search results. The interest levels information may, in turn, be used by the system to tailor subsequent rendering of non-displayed search results to the user.

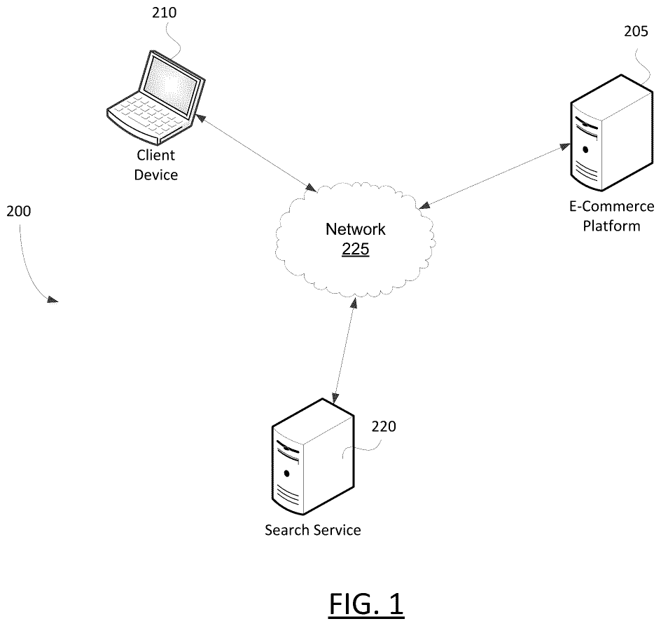

Reference is first made to FIG. 1, which illustrates, in block diagram form, an example computing environment 200 for executing search queries. The components of the computing environment 200 may cooperate to facilitate searches that are initiated by users of various information systems, such as an e-commerce platform, a social networking server, and the like. As shown in FIG. 1, the computing environment 200 may include client devices 210, an e-commerce platform 205, a search service 220, and a network 225 connecting the components of computing environment 200.

As illustrated, the client device 210 and the e-commerce platform 205 can communicate via the network 225. In at least some embodiments, the client device 210 may be a computing device. The client device 210 may take a variety of forms including, for example, a mobile communication device such as a smartphone, a tablet computer, a wearable computer (such as a head-mounted display or smartwatch), a laptop or desktop computer, or a computing device of another type. The client device 210 includes various client applications. A client application may, for example, be a dedicated retail application associated with an e-commerce platform and/or a merchant. In particular, the client application may be used for accessing an e-commerce platform and/or a merchant's online store on the client device 210.

The search service 220 comprises a computing system that is configured to execute various types of searches, such as semantic search, lexical search, and the like. The search service 220 may also be configured to mine data that is available in databases or open repositories. The search service 220 receives search queries from users of information systems and performs searches (e.g., web search, structured data search, etc.) based on the queries. FIG. 1 illustrates the search service 220 as being external to the e-commerce platform 205. The search service 220 may, for example, be a third-party external service that is accessible to the e-commerce platform 205. In some embodiments, however, the search service 220 may be integrated into, and/or implemented as part of, the e-commerce platform 205. The search service 220 is configured to process search queries from users (e.g., customers, merchants, etc.) of the e-commerce platform 205 and provide search results as responses to the search queries. For example, search queries that are based on input from platform users of the e-commerce platform 205 may be transmitted to the search service 220, and search results obtained by the search service 220 may be delivered to the platform users via the e-commerce platform 205.

The network 225 is a computer network. In some embodiments, the network 225 may be an internetwork such as may be formed of one or more interconnected computer networks. For example, the network 225 may be or may include an Ethernet network, an asynchronous transfer mode (ATM) network, a wireless network, or the like.

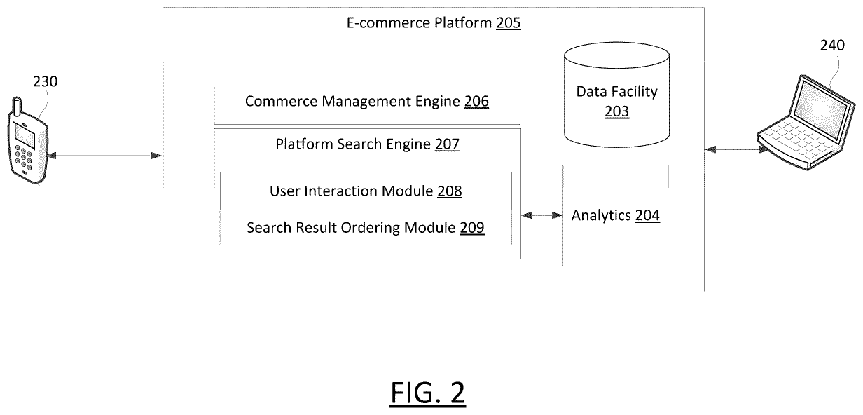

Reference is made to FIG. 2 which illustrates an example embodiment of an e-commerce platform 205 that implements a platform search engine 207. The customer devices 230 and the merchant system 240 may be communicably connected to the e-commerce platform 205. In at least some embodiments, the customer devices 230 and the merchant system 240 may be associated with accounts of the e-commerce platform 205. Specifically, the customer devices 230 and the merchant system 240 may be associated with entities (e.g., individuals) that have accounts in connection with the e-commerce platform 205. For example, one or more customer devices 230 and merchant system 240 may be associated with customers (e.g., customers having e-commerce accounts) or merchants having one or more online stores in the e-commerce platform 205.

The e-commerce platform 205 includes a commerce management engine 206, a platform search engine 207, a data facility 203, and an analytics module 204 for handling analytics relating to merchant products. The commerce management engine 206 may be configured to handle various operations in connection with e-commerce accounts that are associated with the e-commerce platform 205. For example, the commerce management engine 206 may be configured to retrieve e-commerce account information for various entities (e.g., merchants, customers, etc.) and historical account data, such as transaction events data, browsing history data, and the like, for selected e-commerce accounts. In particular, the commerce management engine 206 may obtain account information for e-commerce accounts of customers and/or merchants associated with the e-commerce platform 205.

The functionality described herein may be used in commerce to provide improved customer or buyer experiences. The e-commerce platform 205 could implement the functionality for any of a variety of different applications, examples of which are described herein. Although the platform search engine 207 of FIG. 2 is illustrated as a distinct component of the e-commerce platform 205, this is only an example. An engine could also or instead be provided by another component residing within or external to the e-commerce platform 205. In some embodiments, one or more applications that are associated with the e-commerce platform 205 may provide an engine that implements the functionality described herein to make it available to customers and/or to merchants. Furthermore, in some embodiments, the commerce management engine 206 may provide that engine. However, the location of the platform search engine 207 may be implementation specific. In some implementations, the platform search engine 207 may be provided at least in part by an e-commerce platform, either as a core function of the e-commerce platform or as an application or service supported by or communicating with the e-commerce platform. Alternatively, the platform search engine 207 may be implemented as a stand-alone service to clients such as a customer device or a merchant device. In addition, at least a portion of such an engine could be implemented in the merchant device and/or in the customer device. For example, a customer device could store and run an engine locally as a software application.

The platform search engine 207 is configured to implement at least some of the functionality described herein. Although the embodiments described below may be implemented in association with an e-commerce platform, such as (but not limited to) the e-commerce platform 205, the embodiments described below are not limited to e-commerce platforms.

A user interaction module 208 is illustrated in FIG. 2. The user interaction module 208 is configured to obtain interaction data representing user interaction, either explicit or implicit, with search results that are displayed on the user's device. The display of search results may be governed, at least initially, by certain default rules or policies of a platform search engine 207. For example, in some embodiments, search results may be displayed to a user in accordance with a display order that is determined by a service executing the search, e.g., according to a search result ranking algorithm of the service. The user interaction module 208 collects data that is representative of a user's interactions with search results. The interaction data may, for example, indicate user actions that are detected via a user interface in connection with searched results that are displayed on the user interface. The interaction data may include signals or indicators of user interest in connection with the search results such as, for example, click or scroll events, dwell time, and the like.

FIG. 2 also illustrates a search result ordering module 209. The search result ordering module 209 is configured to determine an order of display of search results associated with the platform search engine 207. For example, the search result ordering module 209 may obtain a set of search results for a search that is initiated by a user of the e-commerce platform 205 and determine an order in which the search results are to be displayed to the user, for example, on the user's device. In at least some embodiments, the search result ordering module 209 may receive indication of an initial display order for a search result set and determine a display order that is different from the initial order. In particular, the search result ordering module 209 may dynamically update a display order of non-displayed search results based on interaction data representing user interaction with displayed subsets of the search results.

The data facility 203 may store data collected by the e-commerce platform 205 based on the interaction of merchants and customers with the e-commerce platform 205. For example, merchants provide data through their online sales activity. Examples of merchant data for a merchant include, without limitation, merchant identifying information, product data for products offered for sale, online store settings, geographical regions of sales activity, historical sales data, and inventory locations. Customer data, or data which is based on the interaction of customers and prospective purchasers with the e-commerce platform 205, may also be collected and stored in the data facility 203. Such customer data is obtained on the basis of inputs received via customer devices associated with the customers and/or prospective purchasers. By way of example, historical transaction events data including details of purchase transaction events by customers on the e-commerce platform 205 may be recorded and such transaction events data may be considered customer data. Such transaction events data may indicate product identifiers, date/time of purchase, final sale price, purchaser information (including geographical region of customer), and payment method details, among others. Other data vis-à-vis the use of e-commerce platform 205 by merchants and customers (or prospective purchasers) may be collected and stored in the data facility 203.

The data facility 203 may include customer preference data for customers of the e-commerce platform 205. For example, the data facility 203 may store account information, order history, browsing history, and the like, for each customer having an account associated with the e-commerce platform 205. The data facility 203 may additionally store, for a plurality of e-commerce accounts, wish list data and cart content data for one or more virtual shopping carts.

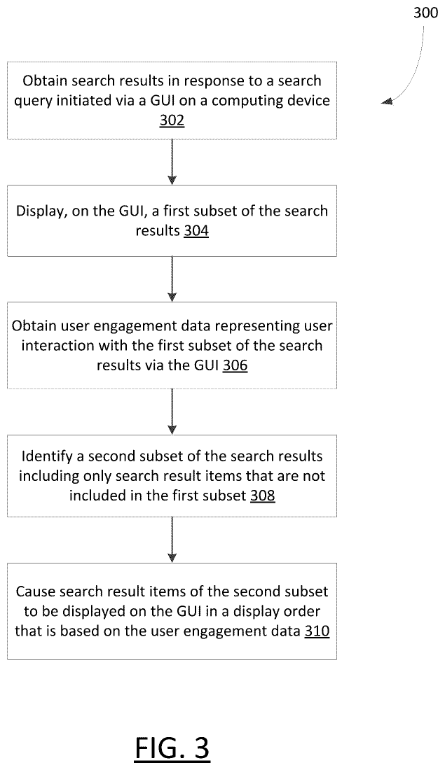

Reference is now made to FIG. 3, which shows, in flowchart form, an example method 300 for controlling display of search results on a computing device. The method 300 may be performed by a computing device associated with an information system, such as the e-commerce platform 220 of FIG. 1. For example, a platform search engine of an e-commerce platform may perform all or parts of the method 300. In particular, a computing device that is configured for processing search results associated with user search queries may implement the method 300.

Users of an information system may initiate searches of data associated with the information system. The information system may provide a search interface which users can use to input their search queries. The search interface may be provided, for example, via a graphical user interface for accessing the information system on user devices. For example, the search interface may be included in a graphical user interface of a web browser or a dedicated mobile application for accessing features of the information system.

The search may be any one of different types of searches such as multimedia search, image search, plain text search, voice search, audio search, video search, etc., and the search interface may enable user input of search queries. The search interface may also enable users to define additional search criteria or options. Upon receiving a user search query, a computing device associated with the information system causes a search to be performed in connection with the user search query. For example, the computing device may itself execute the search or request a search service to perform the search. The search may, in some embodiments, be a search of structured data (e.g., merchant databases, etc.) that is associated with the information system.

In operation 302, the computing device obtains first search results in connection with the search query. The first search results may be obtained from a third-party search service that performs the search or as the output of a search performed by a search engine or module implemented for the information system. The first search results may comprise a finite set of results of the search. For example, the computing device may obtain the entire result set for the search query, in operation 302. Alternatively, the first search results may comprise a subset of a larger set of results of the search. In particular, the computing device may be configured to retrieve only a subset of results for the search query in operation 302. The search results may, for example, be streamed (i.e., retrieved/received) piecemeal from a search service that performs the search.

Upon obtaining the first search results, the computing device causes to be displayed, on the graphical user interface, a first subset of the first search results, in operation 304. The first subset represents an initial subset of the first search results that are displayed on the graphical user interface. In particular, the computing device determines a subset of the first search results that is to be initially displayed in response to the user search query. In other words, the first subset includes one or more of the first search results that have yet to be displayed on the graphical user interface.

The first search results may be associated with an initial order of display, or a search result ranking. For example, the first search results may have an initial ranking, with each of the first search results being associated with a respective rank. The initial order/ranking may be determined by the computing device itself or a third-party search service that performs the search for the user search query. When determining the first subset of the first search results, the computing device may select a defined number of the highest ranked first search results. That is, the first subset may include one or more highest ranked of the first search results.

In some embodiments, the initial order/ranking associated with the first search results may be determined by the search algorithm that is employed for the search. Specifically, the initial order/ranking may be an order/ranking of the first search results as output by the search algorithm. The computing device may receive an indication of this initial order/ranking when obtaining the first search results, either from an external search service or from an internal search engine. Alternatively, the computing device may obtain the first search results and itself determine an order/ranking for the set. That is, the computing device may not rely on the search algorithm for the initial order/ranking and instead determine anew the order/ranks for each of the first search results. The “new” order/ranking of the first search results may be determined based on information about the user, such as the user's search history, current geographical location, past click or scroll behavior, etc.

The first subset of the first search results may be determined, at least in part, based on properties of the graphical user interface. Specifically, a number of the first search results for inclusion in the first subset may depend on physical dimensions associated with the graphical user interface. For example, the computing device may determine display dimensions (e.g., available display space) of the graphical user interface and a maximum number of the first search results that can be displayed concurrently in an initial search results page on the graphical user interface. The first subset may then be determined by selecting said maximum number of the highest ranked first search results.

Subsequent to display of the first subset of the first search results on the graphical user interface, the computing device may monitor user engagement with the first subset. In particular, the computing device may determine how a user interacts with information that is displayed on the graphical user interface in connection with the search results of the first subset. A user may interact with the displayed information by, for example, reviewing a list of the search results (e.g., by scrolling on a search results page), selecting one or more of the search results, or viewing additional information associated with one or more of the search results (e.g., by navigating to a linked page). User engagement with the first subset of the first search results may comprise user actions and/or reactions detected by the computing device via the graphical user interface.

In operation 306, the computing device obtains user engagement data representing user interaction with the displayed first subset of the first search results. In at least some embodiments, user engagement data may include first data characterizing one or more user interface actions performed subsequent to display of the first subset of the first search results on the graphical user interface. The user interface actions may include, for example, a click action. Another example of a user interface action is a scroll action, and the first data may indicate, for the scroll action, at least one of a scroll speed or changes in scroll position and/or direction. The computing device may monitor for click or scroll events after the first subset of the first search results are displayed on the graphical user interface, and the click/scroll events that are detected by the computing device may form the basis for characterizing user interaction with individual ones of the displayed search results. The click or scroll events may be detected by, for example, monitoring user input received via an input interface, such as a mouse, trackpad, touchscreen, etc., associated with the user's device. For any detected click or scroll events, the computing device may determine certain qualitative and quantitative data such as, for example, scroll speed, scroll direction, scroll positions, cursor hover time, number of clicks, impressions (or view-throughs), and the like.

By monitoring user interaction with displayed search results, the computing device may infer the user's expressed interest in the search results. In particular, the computing device may determine, for each search result of the first subset, an indication of the user's interest level associated with the search result. Certain user actions or reactions may be indicative of high relative user interest. For example, user engagement data representing a decrease in scroll speed, a prolonged period of cursor hover, a selection by the user, a scrolling back to a previous scroll position, and the like, in connection with a displayed search result may indicate a high relative user interest for the search result. On the other hand, user engagement data representing an increase or no change in scroll speed, short period of cursor hover, and the like, in connection with a displayed search result may indicate a low relative user interest for the search result.

A user may be interested in a search result for various reasons. For example, a search result may be associated with information that is of particular interest to the user. In the context of a product search (e.g., a search on an e-commerce platform), the search results may include a plurality of product item listings associated with the product search. A customer may be interested in a search result if one or more product attributes of the associated product are attributes that the user is interested in. More generally, a user may be interested in a displayed search result if the information that is displayed in connection with the search result on the graphical user interface is of interest to the user. The displayed information associated with a search result may include, for example, a representative title or logo, descriptive text (e.g., snippets, excerpts, etc.), preview images, related links, and the like, associated with the search result. The attributes of products may be identified based on, for example, metadata associated with product listings or search results (e.g., description, product categories, etc.) and/or tagging of product listings/search results (e.g., tagged images of products).

By associating the user engagement data for a search result with the displayed information for the search result, the computing device may identify attributes of interest for the user. In particular, the computing device may determine which attributes are associated with user interaction that is indicative of high relative interest for the user and which attributes are associated with user interaction that is indicative of low relative interest for the user. The information regarding the attributes of interest can, in turn, be used by the computing device in determining order of display for further search results, i.e., non-displayed ones of the first search results. In this way, the computing device dynamically determines display orders for non-displayed search results. Specifically, the computing device continuously updates the attributes of interest information for the user based on monitored user engagement with the displayed search results and determines the display orders using current attributes of interest information.

The computing device determines a second subset of the first search results, in operation 308. The second subset includes only search results that are not included in the first subset. In particular, the second subset includes only those of the first search results that have not been displayed on the graphical user interface. In some embodiments, the second subset may comprise the highest ranked of the first search results that are not included in the first subset. For example, the computing device may select a defined number of the next highest ranked first search results (i.e., highest of the search results that are ranked lower than the search results of the first subset) for inclusion in the second subset.

The computing device is configured to control the display of the search results of the second subset. In particular, the computing device determines a display order for the second subset based on user engagement data associated with previously displayed search results (e.g., the first subset). This display order may be different from an initial order associated with the second subset. For example, the display order may be different from an order/ranking of the search results in the second subset that is determined by the search algorithm for the search.

In some embodiments, the computing device determines the display order for the second subset based on assigning, to each of one or more of the search results in the second subset, a rank representing a user interest level associated with the search result. The rank for a search result may be determined based on user engagement data for previously displayed search results. Specifically, the computing device may assign ranks to the search results of the second subset based on attributes of interest information for the user as determined through analysis of user interaction with the displayed first subset of search results. A search result that is associated with one or more attributes of interest for the user may be assigned a higher rank relative to a search result that is not associated with any attribute of interest. More generally, a search result that is associated with a greater number of attributes of interest may be assigned a higher rank than search results that are associated with fewer attributes of interest. In some embodiments, a ranking of the search results may be determined based on weighting of the attributes of interest. In particular, the attributes of interest may be associated with respective weights and the assigned ranks of the search results may be determined using the weights information. An attribute of interest may be determined to be significant for a user if the attribute is associated with a large number of the search results that the user is interested in, as determined based on user engagement data. A significant attribute of interest may be associated with a higher weight relative to an attribute that is determined to be less significant for the user.

Upon determining a display order for the second subset, the computing device causes search result items of the second subset to be displayed on the graphical user interface according to the display order, in operation 310. The computing device may generate instructions for displaying the second subset in accordance with this display order, and transmit the instructions to the user's device. In particular, the instructions may be provided to an application, such as a web browser or a dedicated mobile app, that is currently used to access the search results (e.g., a search interface).

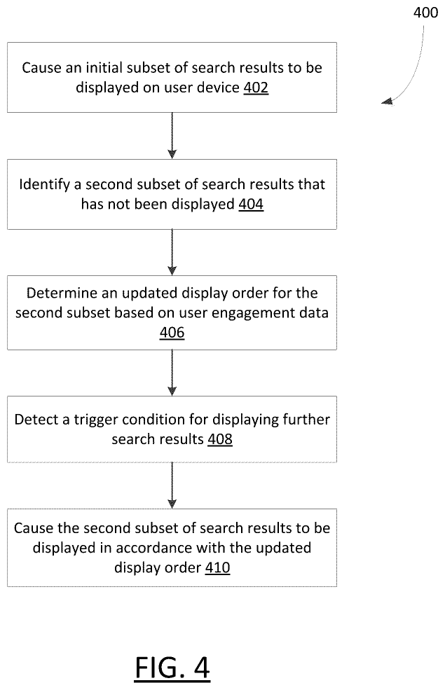

Reference is now made to FIG. 4, which shows, in flowchart form, an example method 400 for determining an order of display of search results. The method 400 may be performed by a computing device associated with an information system, such as the e-commerce platform 220 of FIG. 1. For example, a platform search engine of an e-commerce platform may perform all or parts of the method 400. In particular, a computing device that is configured for processing search results associated with user search queries may implement the method 400. The operations of method 400 may be performed in addition to, or as alternatives of, one or more operations of method 300.

A computing device associated with an information system may receive a request to perform a search on certain data associated with the information system. For example, the computing device may receive a search query from a user of the information system. Upon receiving the user search query, the computing device may cause a suitable search to be executed. The search may be performed by the computing device, for example, by a search engine implemented as part of or in connection with the computing device. Alternatively, the computing device may request an external search service to perform the search based on the user search query.

The computing device obtains search results in connection with the search. In operation 402, the computing device causes an initial subset of the search results to be displayed via a graphical user interface on the user device. The initial subset is a set of search results that is selected for displaying on the user device. In some embodiments, the initial subset may include a defined number of the highest ranked search results. The search results may be associated with an initial ranking such as, for example, a ranking assigned by the search algorithm for the search. This initial ranking may be used to select the search results that are to be included in the initial subset. The computing device transmits, to the user device, an indication of the initial subset of search results and instructions for displaying those search results.

In operation 404, the computing device identifies a second subset of the search results that have not been displayed on the graphical user interface. The second subset is a set of search results that have been obtained by the computing device but have not yet been caused to be displayed on the user device. In particular, the second subset is a set of search results that is different from the initial subset. In some embodiments, the second subset may include a defined number of the next highest ranked search results, i.e., highest of the search results that are ranked lower than the search results of the initial subset. That is, the computing device may select the second subset using a search result ranking. The ranking may be determined by the search algorithm for the search (e.g., an algorithm implemented by an external search service), or it may be determined by the computing device independently of the search algorithm.

The computing device determines an updated display order for the second subset based on user engagement data, in operation 406. As described with reference to the method 300 of FIG. 3, user interaction with displayed search results on a graphical user interface may inform the determination of user interest levels associated with the search results. In particular, user engagement data indicative of user interaction with displayed search results may be used in identifying attributes of interest for the user in connection with the search results. The attributes of interest information may, in turn, inform the determination of a display order for as-yet non-displayed search results. The updated display order may thus be determined based on user engagement data obtained by the computing device. The user engagement data may identify one or more user interface actions such as click and scroll actions and include certain quantitative and qualitative data such as, for example, scroll speed, scroll direction, scroll positions, cursor hover time, number of clicks, impressions (or view-throughs), and the like.

In operation 408, the computing device detects a defined trigger condition for displaying further search results in connection with the search. If a user desires to view more than just the initial subset of the search results, the user may request for more search results. For example, the user may provide, on the user's device, user input for requesting to access additional search results, i.e., one or more of the currently non-displayed search results. A trigger condition is associated with a user request for additional search results. For example, a trigger condition may include at least one of: a scroll event, a selection of a user interface element, or a selection of a redirect link (e.g., a link to return to a listing of search results).

In response to detecting the trigger condition, the computing device causes the second subset of the search results to be displayed in accordance with the updated display order via the graphical user interface, in operation 410. The computing device may transmit, to the user device, an indication of the second subset of the search results and a display order for presenting the second subset on the graphical user interface.

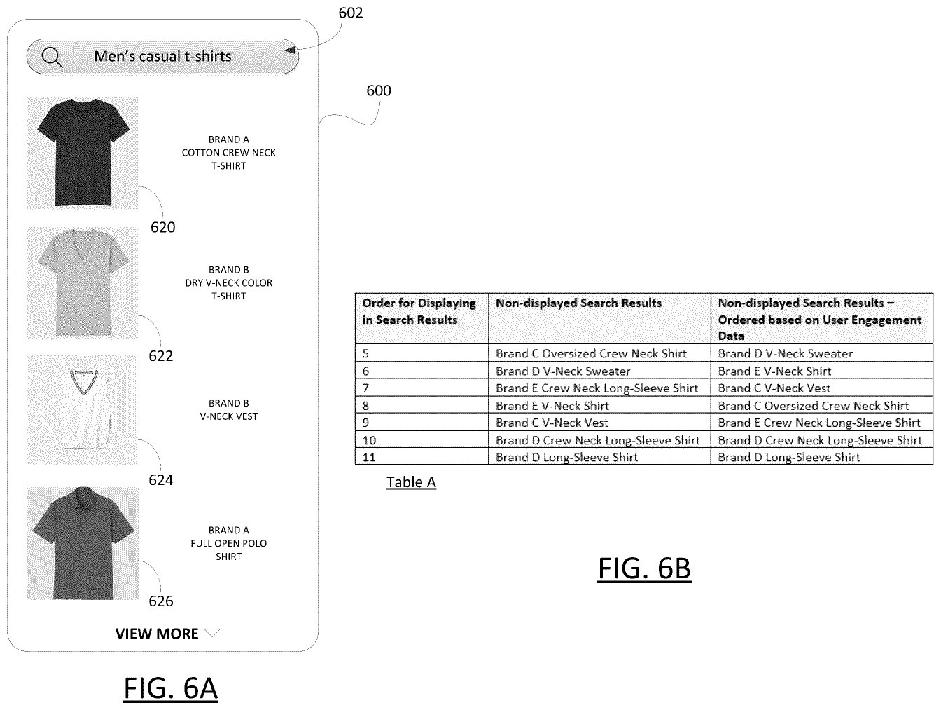

FIG. 6A illustrates an example graphical user interface that may be used for a product search. Specifically, a results page 600 for a search query 602 is shown in FIG. 6A. The results query 602. The displayed search results 620-626 on results page 600 may correspond to an initial subset of the results associated with the search query (i.e., “men's casual t-shirts”) 602. A user may access additional information about the displayed search results by, for example, clicking on a search result to navigate to an associated product page. The user can also request to “view more” results, i.e., non-displayed search results associated with the search query 602. In particular, the user can request for further results to be displayed either expressly (e.g., clicking on “View More”) or indirectly by, for example, scrolling the results page 600.

The display of further search results may be determined in accordance with embodiments described herein. Table A of FIG. 6B illustrates one example scenario. The table shows a set of non-displayed search results for the search query 602. Table A may be used for determining items 5 through to 11 to display on the results page 600 subsequent to the four results 620-626 shown in FIG. 6A. In particular, the non-displayed search results are ordered based on user engagement data representing engagement with the displayed search results of FIG. 6A. For example, the user engagement data (e.g., scroll speed, hover time, etc.) may indicate a high relative user interest for search results that are associated with “v-necks” (i.e., search results 622 and 624). The attribute “v-neck” of t-shirt products may then be determined to be an attribute of interest. The non-displayed search results may be re-ordered, as shown in column 3 of Table A, such that those search results that are associated with “v-neck” attribute are assigned a higher rank and therefore arranged to be displayed before other search results without said attribute on the results page 600. The eventual display of the non-displayed search results is based on the updated order of search results illustrated in column 3 of Table A.

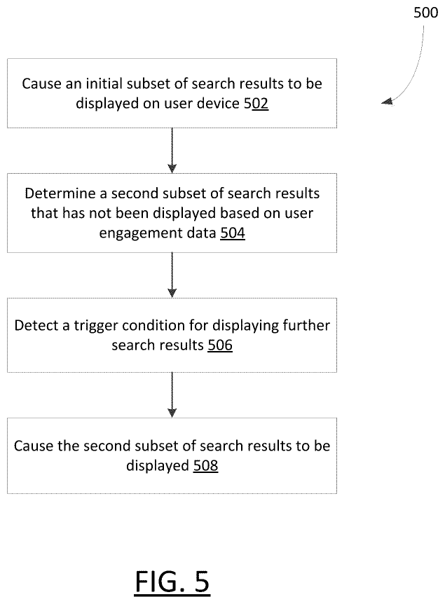

Reference is now made to FIG. 5, which shows, in flowchart form, another example method 500 for determining an order of display of search results. The method 500 may be performed by a computing device associated with an information system, such as the e-commerce platform 220 of FIG. 1. For example, a platform search engine of an e-commerce platform may perform all or parts of the method 500. In particular, a computing device that is configured for processing search results associated with user search queries may implement the method 500. The operations of method 500 may be performed in addition to, or as alternatives of, one or more of the operations of methods 300 and 400.

In response to receiving a search request for an information system, a computing device associated with the information system causes a search to be executed in connection with the search request. For example, a user search query may be received at the computing device, and a search associated with the user search query may be initiated by the computing device. In operation 502, the computing device causes an initial subset of the search results for the search to be displayed via a graphical user interface on a computing device. The initial subset is a set of search results that is selected for displaying on the user device. In some embodiments, the initial subset may include a defined number of the highest ranked search results. The search results may be associated with an initial ranking such as, for example, a ranking assigned by the search algorithm for the search. This initial ranking may be used to select the search results that are to be included in the initial subset. The computing device transmits, to the user device, an indication of the initial subset of search results and instructions for displaying those search results.

The computing device determines a second subset of the search results based on user engagement data, in operation 504. The user engagement data represents interaction of a user with the display of the initial subset of the search results on the graphical user interface. Unlike in the method 400 of FIG. 4, the user engagement data informs selection of the second subset of non-displayed search results, in operation 504. As described above, user engagement data is used for determining a display order for currently non-displayed subset of search results in method 400. Specifically, the user engagement data enables a computing device to infer a user's interest levels associated with displayed search results, and the interest levels information is used for identifying attributes of interest for the user. The display orders for further (i.e., currently non-displayed) search results are determined based on the attributes of interest.

In contrast, the computing device selects a second subset of the non-displayed search results using the user engagement data, in operation 504. Rather than ordering a selected subset of search results based on the user engagement data, the method 500 includes selecting subsequent search results for display according to data representing the user interaction with previously displayed search results (e.g., the initial subset). This represents a different approach to controlling the display of currently non-displayed search results of a search on the user device. In particular, the user engagement data is represented at a step of selecting subsequent search results to display rather than at a step of ordering a selected subset of non-displayed search results.

In operation 506, the computing device detects a trigger condition for displaying further search results. the computing device detects a defined trigger condition for displaying further search results in connection with the search. If a user desires to view more than just the initial subset of the search results, the user may request for more search results. For example, the user may provide, on the user's device, user input for requesting to access additional search results, i.e., one or more of the currently non-displayed search results. A trigger condition is associated with a user request for additional search results. For example, a trigger condition may include at least one of: a scroll event, a selection of a user interface element, or a selection of a redirect link (e.g., a link to return to a listing of search results).

In response to detecting the trigger condition, the computing device causes the second subset of the search results to be displayed in accordance with the updated display order via the graphical user interface, in operation 508. The computing device may transmit, to the user device, an indication of the second subset of the search results and a display order for presenting the second subset on the graphical user interface.

In some embodiments, the user engagement data with displayed search results may be represented at a step of retrieving further search results. That is, user engagement with currently displayed search results may affect how further search results (i.e., currently non-retrieved results) of a search query are obtained by the computing device from, for example, a search module or service performing the search. For example, the user engagement data may inform the search query for further search results by modifying/updating the search to include one or more identified attributes of interest as search parameters for further searches. As another example, the user engagement data may inform an order in which to retrieve results of a search that has already been performed by the search service/module. In this way, the retrieval of search results may be based on the user engagement data. In particular, user engagement data representing a user's engagement with displayed results of a search initiated by the user may be employed for re-ordering retrieved search results that have yet to be displayed to the user and/or informing how to retrieve further search results.

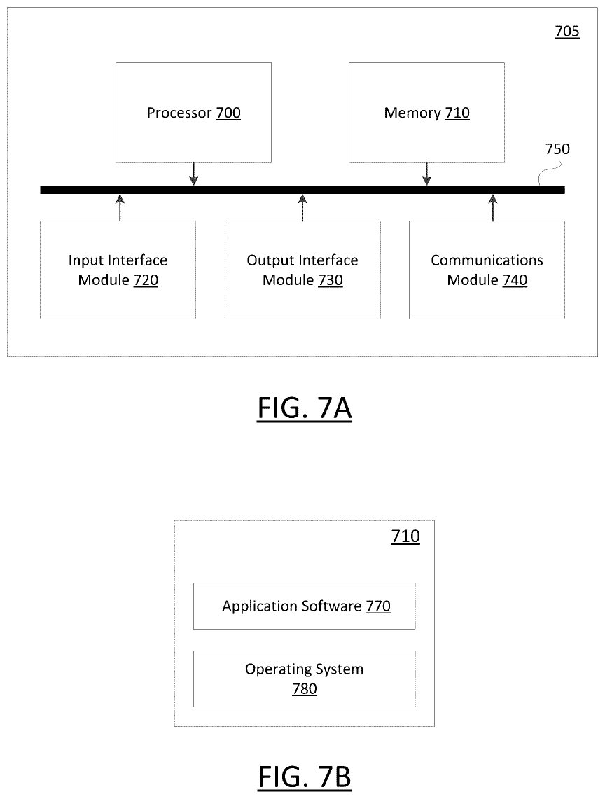

The above-described methods may be implemented by way of a suitably programmed computing device. FIG. 7A is a high-level operation diagram of an example computing device 705. The example computing device 705 includes a variety of modules. For example, as illustrated, the example computing device 705, may include a processor 700, a memory 710, an input interface module 720, an output interface module 730, and a communications module 740. As illustrated, the foregoing example modules of the example computing device 705 are in communication over a bus 750.

The processor 700 is a hardware processor. The processor 700 may, for example, be one or more ARM, Intel x86, PowerPC processors or the like.

The memory 710 allows data to be stored and retrieved. The memory 710 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 705.

The input interface module 720 allows the example computing device 705 to receive input signals. Input signals may, for example, correspond to input received from a user. The input interface module 720 may serve to interconnect the example computing device 705 with one or more input devices. Input signals may be received from input devices by the input interface module 720. Input devices may, for example, include one or more of a touchscreen input, keyboard, trackball or the like. In some embodiments, all or a portion of the input interface module 720 may be integrated with an input device. For example, the input interface module 720 may be integrated with one of the aforementioned examples of input devices.

The output interface module 730 allows the example computing device 705 to provide output signals. Some output signals may, for example allow provision of output to a user. The output interface module 730 may serve to interconnect the example computing device 705 with one or more output devices. Output signals may be sent to output devices by output interface module 730. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some embodiments, all or a portion of the output interface module 730 may be integrated with an output device. For example, the output interface module 730 may be integrated with one of the aforementioned example output devices.

The communications module 740 allows the example computing device 705 to communicate with other electronic devices and/or various communications networks. For example, the communications module 740 may allow the example computing device 705 to send or receive communications signals. Communications signals may be sent or received according to one or more protocols or according to one or more standards. For example, the communications module 740 may allow the example computing device 705 to communicate via a cellular data network, such as for example, according to one or more standards such as, for example, Global System for Mobile Communications (GSM), Code Division Multiple Access (CDMA), Evolution Data Optimized (ENDO), Long-term Evolution (LTE) or the like. Additionally, or alternatively, the communications module 740 may allow the example computing device 705 to communicate using near-field communication (NFC), via Wi-Fi™, using Bluetooth™ or via some combination of one or more networks or protocols. Contactless payments may be made using NFC. In some embodiments, all or a portion of the communications module 740 may be integrated into a component of the example computing device 705. For example, the communications module may be integrated into a communications chipset.

Software comprising instructions is executed by the processor 700 from a computer-readable medium. For example, software may be loaded into random-access memory from persistent storage of memory 710. Additionally, or alternatively, instructions may be executed by the processor 700 directly from read-only memory of memory 710.

FIG. 7B depicts a simplified organization of software components stored in memory 710 of the example computing device 105. As illustrated these software components include an operating system 780 and application software 770.

The operating system 780 is software. The operating system 780 allows the application software 770 to access the processor 700, the memory 710, the input interface module 720, the output interface module 730, and the communications module 740. The operating system 780 may be, for example, Apple™ OS X, Android™, Microsoft™ Windows™, a Linux distribution, or the like.

The application software 770 adapts the example computing device 705, in combination with the operating system 780, to operate as a device performing particular functions.

### Example E-commerce Platform

Although integration with a commerce platform is not required, in some embodiments, the methods disclosed herein may be performed on or in association with a commerce platform such as an e-commerce platform. Therefore, an example of a commerce platform will be described.

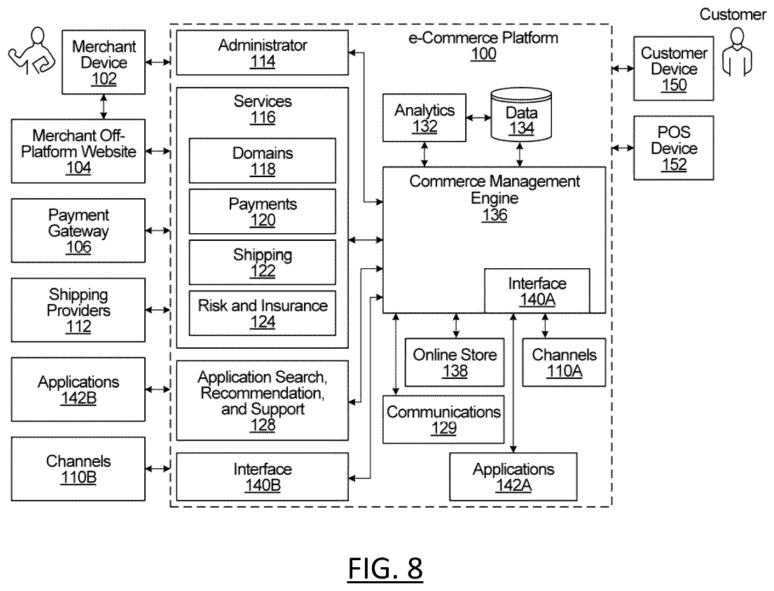

FIG. 8 illustrates an example e-commerce platform 100, according to one embodiment. The e-commerce platform 100 may be exemplary of the e-commerce platform 220 described with reference to FIG. 1. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a “merchant” and a “customer” may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to “merchants” and “customers”, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 8, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point-of-sale (POS) devices 152 in physical locations (e.g., a physical storefront or other location such as through a kiosk, terminal, reader, printer, 3D printer, and the like).

A merchant may utilize the e-commerce platform 100 as a sole commerce presence with customers, or in conjunction with other merchant commerce facilities, such as through a physical store (e.g., “brick-and-mortar” retail stores), a merchant off-platform website 104 (e.g., a commerce Internet website or other internet or web property or asset supported by or on behalf of the merchant separately from the e-commerce platform 100), an application 142B, and the like. However, even these “other” merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through “buy buttons” that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point-of-sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally, or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment facility 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

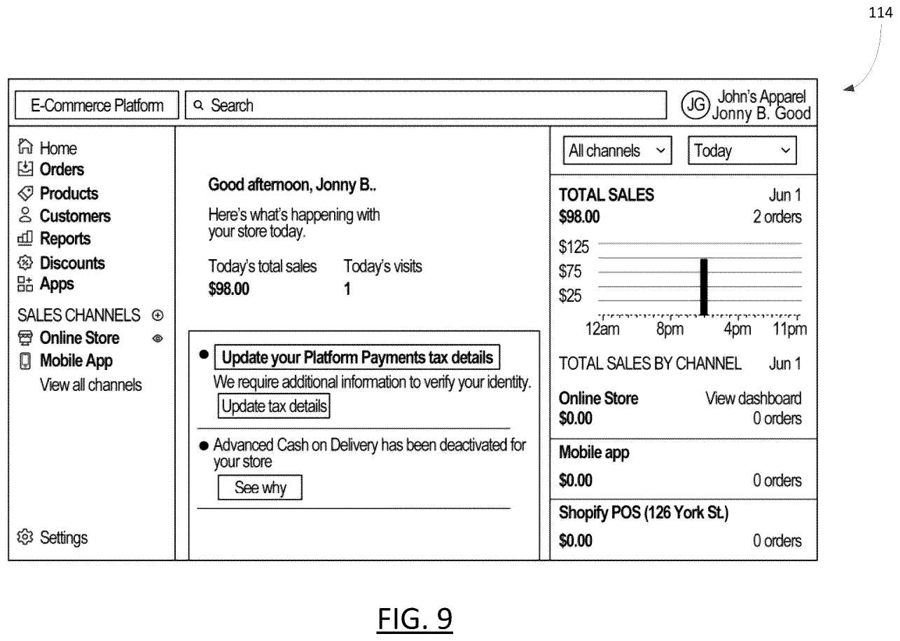

FIG. 9 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 9. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a “view all recent activity” dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, clickthrough events), product reviews, abandoned carts, and/or other transactional information associated with business through the e-commerce platform 100. In some embodiments, the e-commerce platform 100 may store this data in a data facility 134. Referring again to FIG. 8, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method, comprising:
obtaining search results in response to a search query initiated via a graphical user interface on a computing device;
displaying, on the graphical user interface, a first subset of the search results;
obtaining user engagement data representing user interaction with the first subset of the search results via the graphical user interface;
determining a second subset of the search results including only search result items that are not included in the first subset; and
causing search result items of the second subset to be displayed on the graphical user interface in a display order that is based on the user engagement data.

2. The method of claim 1, further comprising determining the display order based on assigning, to each of one or more of the search result items of the second subset, a rank representing a user interest level associated with the search result item based on the user engagement data.

3. The method of claim 2, wherein the rank that is assigned to a search result item is based on the user engagement data and attributes of interest associated with one or more search result items of interest from the first subset.

4. The method of claim 1, wherein the user engagement data comprises first data characterizing one or more user interface actions performed subsequent to display of the first subset of the search results on the graphical user interface.

5. The method of claim 4, wherein the one or more user interface actions comprise a click action.

6. The method of claim 4, wherein the one or more user interface actions comprise a scroll action and wherein the first data indicates, for the scroll action, at least one of a scroll speed or changes in scroll position.

7. The method of claim 1, wherein the user engagement data comprises second data characterizing passive interaction with the first subset of the search results.

8. The method of claim 7, wherein the second data comprises at least one of view-through data or a dwell time associated with a search result item.

9. The method of claim 1, wherein the search query comprises a product search performed on an e-commerce platform and the search results comprise a plurality of product item listings associated with the product search.

10. The method of claim 1, wherein the search query comprises an app search performed on a software distribution platform and the search results comprise a plurality of app listings associated with the app search.

11. The method of claim 1, further comprising detecting a defined trigger condition for displaying further search results, wherein the second subset of the search results is caused to be displayed responsive to detecting the defined trigger condition.

12. The method of claim 11, wherein the defined trigger condition comprises at least one of a scroll action, a selection of a user interface element, or a selection of a redirect link to return to a listing of the search results.

13. A computing device, comprising:
a processor;
a memory coupled to the processor, the memory storing instructions that, when executed by the processor, configure the processor to:
obtain search results in response to a search query initiated via a graphical user interface on a computing device;
display, on the graphical user interface, a first subset of the search results;
obtain user engagement data representing user interaction with the first subset of the search results via the graphical user interface;
determine a second subset of the search results including only search result items that are not included in the first subset; and
cause search result items of the second subset to be displayed on the graphical user interface in a display order that is based on the user engagement data.

14. The computing device of claim 13, wherein the instructions, when executed, further configure the processor to determine the display order based on assigning, to each of one or more of the search result items of the second subset, a rank representing a user interest level associated with the search result item based on the user engagement data.

15. The computing device of claim 14, wherein the rank that is assigned to a search result item is based on the user engagement data and attributes of interest associated with one or more search result items of interest from the first subset.

16. The computing device of claim 13, wherein the user engagement data comprises first data characterizing one or more user interface actions performed subsequent to display of the first subset of the search results on the graphical user interface.

17. The computing device of claim 16, wherein the one or more user interface actions comprise a click action or a scroll action.

18. The computing device of claim 13, wherein the user engagement data comprises second data characterizing passive interaction with the first subset of the search results.

19. The computing device of claim 18, wherein the second data comprises at least one of view-through data or a dwell time associated with a search result item.

20. A non-transitory, computer-readable medium storing computer-executable instructions that, when executed by a processor, configure the processor to:
obtain search results in response to a search query initiated via a graphical user interface on a computing device;
display, on the graphical user interface, a first subset of the search results;
obtain user engagement data representing user interaction with the first subset of the search results via the graphical user interface;
determine a second subset of the search results including only search result items that are not included in the first subset; and
cause search result items of the second subset to be displayed on the graphical user interface in a display order that is based on the user engagement data.
